(19) United States
(12) Patent Application Publication
(10) Pub. No.: US 2015/0314310 A1
(43) Pub. Date: Nov. 5, 2015

(54) SPRAY GUN CAP, INJECTOR AND PRESSURE SYSTEM

(71) Applicant: ÉQUIPEMENT DE FINITION DU QUÉBEC INC., Lachine (CA)

(72) Inventor: Leon Bier, Cote Saint-Luc (CA)

(73) Assignee: EQUIPMENT DE FINITION DU QUEBEC INC., Lachine, QC (CA)

(21) Appl. No.: 14/651,565

(22) PCT Filed: Dec. 11, 2013
(86) PCT No.: PCT/CA13/50950

§ 371 Date: Jun. 11, 2015

Related U.S. Application Data
(60) Provisional application No. 61/735,718, filed on Dec. 11, 2012.

(51) Int. Cl. B05B 7/24

(52) U.S. Cl. CPC B05B 7/2497

(57) ABSTRACT

A cap for a spray gun for spraying a mixture of a first fluid and a second fluid. The cap includes a base removably mountable to the spray gun. The base has an aperture in fluid communication with a supply of the first fluid upon being mounted to the spray gun, the aperture configured for spraying the first fluid. A secondary port receives the second fluid to be mixed with the first fluid. A removable conduit conveys under pressure the second fluid to the secondary port, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid, thereby forming the mixture. A pressure system for the spray gun is also provided.

### FIELD OF THE INVENTION

The present invention relates to spray guns and pressure systems. More particularly, the present invention relates to a cap for a spray gun, a removable injector and a pressure system.

### BACKGROUND

Spray guns are known in the art. These guns are typically hand-held or automatic, and they can be used to apply a spray pattern of material to a surface, thus coating the surface. The spray is generated because the guns typically operate at pressures above atmospheric pressure, and the spray pattern can vary depending on numerous factors.

Spray guns can be used to apply many different materials to a surface. One such material is paint. With paint, the spray gun is used to coat a relatively large surface with paint, relatively quickly. Another such material is glue. With glue, the spray gun is used to apply glue to a surface.

Some manufacturers and/or brands of spray guns include: GRACO®; DeVilbiss®; and BINKS®.

A prior art “2K” (i.e. two component) spray gun (S) used for spraying glue and an activator/catalyst is shown in FIGS. 1 and 2. When spraying glue under pressure with a spray gun, it is often required to use an activator or catalyst. The activator or catalyst can be any solution which is injected into and/or with the glue, under pressure, thereby mixing at least partially with the glue and helping it to bond, or to bond better, to the surface to which it is applied.

In FIGS. 1 and 2, the glue and the activator are both emitted near the spray of the spray gun (S) and its head (H). The glue is emitted from the central hole (C) of the head (H), whereas the activator is emitted into the glue spray from a horn (R), thereby mixing both the glue and activator. The activator is brought to the horn (R) under pressure via a tube (T), which is connected at its other end to a valve (V). The tube (T) can be fitted to an injector (P), which is mounted to the horn (R).

Such known spray guns and/or some of their components present some of the following disadvantages, especially when used to spray glue mixed with an activator: a) when the injector clogs or gums up, as often occurs, it can be difficult to unclog or clean; b) the injector can be easily damaged and even broken when the spray gun is dropped or otherwise impacted; c) the injector is typically made from metal or other materials, and can be expensive and difficult to machine in the relatively small sizes required to inject the small volume of activator required; d) the injector can be relatively costly to replace when it is broken or clogged; e) replacing the clogged injector can require the operator to shut down the pressure supply for the gun, take apart the head of the spray gun, clean the injector which is difficult given its size and its small orifice, reassemble everything, and resupply the pressure to the gun, a process which is cumbersome and time-consuming; f) if the injector breaks off in the head of the air cap, the whole cap has to be replaced, etc.

Returning to the example of a spray gun used for spraying glue and an activator, it is known that the pressure for these materials is typically provided via a pressurized tank, or a pressurized system or source. A pressurized tank can contain one of the materials to be sprayed, and the tank can be kept at a certain pressure and linked to the spray gun. The pressurized system is typically a fixed installation, and may consist of fixed pressurization source (i.e. a pump), tubing, and other required hardware.

Also known are some of the following disadvantages of these pressurized tanks and systems: a) the tanks can be bulky, heavy, and difficult to manipulate; b) the tanks are difficult to displace because the operator must often lift the tank and move it manually, which can be strenuous; c) many tanks are made from relatively expensive materials, such as stainless steel; d) some tanks can rust and/or degrade after repeated uses, requiring the operator to remove the degradation and/or replace the tank; e) tanks are often difficult to refill because they require the removal of the entire lid of the tank, which requires the operator to shut down pressure in the system and/or disconnect fittings; f) many systems are not versatile because they must be installed at significant up-front costs in one location; g) etc.

Hence, in light of the aforementioned, there is a need for a device which, by virtue of its design and components, would be able to overcome or at least minimize some of the aforementioned prior art problems.

### SUMMARY

One object of the present invention is to provide a solution to the above-mentioned need.

According to one aspect of the present invention, there is provided a cap for a spray gun for spraying a mixture of a first fluid and a second fluid, the cap comprising:

a base removably mountable to the spray gun, the base comprising:
an aperture in fluid communication with a supply of the first fluid upon being mounted to the spray gun, the aperture configured for spraying the first fluid; and
a secondary port for receiving the second fluid to be mixed with the first fluid;
and

a removable conduit for conveying under pressure the second fluid to the secondary port, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid, thereby forming the mixture.

In some optional configurations, the base may be a cylindrical cap which can be removably mounted to the spray gun. The base can be provided with appropriate seals and/or gaskets so as maintain a certain level of pressure, and so as to prevent the fluids from escaping, among other reasons.

The base may also include at least one support element, and in some configurations two support elements, which can project from the base in a direction away from the gun, thereby delimiting the ultimate width of the spray pattern. The support can include a conduit housing for housing the conduit, which can take many different forms.

In some optional configurations, the release fitting can be press fitted or otherwise securely mounted to the conduit housing so as maintain the flow of the second fluid in a fixed direction. The release fitting can be mounted to a support directly. The conduit can be any flexible tubing extending between both the supply and release fittings. In some configurations, the fittings can be LUER-LOKs™. The release fitting can include a cannula, or other narrowly convergent device.

According to another aspect of the present invention, there is provided a removable fluid injector for a fluid-delivery device for delivering a mixture of a first fluid and a second fluid, the fluid injector comprising:

a removable conduit for conveying under pressure the second fluid to a secondary port of the device, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid emitted by the device, thereby forming the mixture.

According to another aspect of the present invention, there is provided a spray gun system for spraying a mixture of a first fluid and a second fluid, the spray gun comprising a cap, the cap comprising:

a base removably mountable to the spray gun, the base comprising:
an aperture in fluid communication with a supply of the first fluid upon being mounted to the spray gun, the aperture configured for spraying the first fluid; and
a secondary port for receiving the second fluid to be mixed with the first fluid;
and

a removable conduit for conveying under pressure the second fluid to the secondary port, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid, thereby forming the mixture.

According to another aspect of the present invention, there is provided a pressure system for pressurizing a first fluid and a second fluid, the system comprising:

two fluid receptacles, each fluid receptacle comprising a hollow body, each fluid receptacle configured for storing one of the first and second fluids within the hollow body;

two fluid couplers for coupling the receptacles to feed lines of the spray gun system, each coupler mountable to a corresponding receptacle so as to form a pressurized seal with said receptacle; and

a pressurization unit configured for supplying a pressurized fluid to each fluid receptacle, thereby pressurizing the first and second fluids in their corresponding receptacles.

In some optional configurations, the system is provided with a mobile unit, such as a trolley, tray, etc. with which the operator can displace the system as desired.

In some optional configurations, the fluid receptacles are made of a light-weight material, such as plastic or composites, for example. Each fluid receptacle can have inlets, outlets, seals, valves, etc. mounted on their bodies for receiving the fluid and for conveying same under pressure through the fluid couplers. Optionally, the opening can include a funneling structure or a funnel through which the first or second fluid can be more easily added to the receptacle.

Further optionally, the pressurization unit can be a manual or automatic pump, a pressurized system, or any other suitable mechanism. The pressurization unit can be equipped with appropriate valves, gauges, tubing, pipes, etc., as desired.

According to another aspect of the present invention, there is also provided a spray gun equipped with the above-mentioned cap, injector and/or pressure system.

According to another aspect of the present invention, there is also provided a kit with components for assembling the above-mentioned cap, system, injector and/or spray gun.

According to yet another aspect of the present invention, there is also provided a method of operating the above-mentioned cap, system, injector, spray gun and/or kit.

According to yet another aspect of the present invention, there is also provided a set of components for interchanging with components of the above-mentioned kit.

According to yet another aspect of the present invention, there is also provided a method of assembling components of the above-mentioned kit and/or set.

According to yet another aspect of the present disclosure, there is also provided a method of doing business with the above-mentioned cap, system, injector, spray gun, kit, set and/or methods.

Some objects, advantages and other features will become more apparent upon reading the following non-restrictive description of certain optional configurations, given for the purpose of exemplification only, with reference to the accompanying drawings.

### BRIEF DESCRIPTION OF THE DRAWINGS

FIGS. 1 and 2 are various views of a spray gun according to the prior art.

FIG. 3 is a perspective view of a cap shown mounted to a spray gun, according to an optional configuration of the present invention.

FIGS. 4 and 5 are different views of a conduit housing for a support element, according to an optional configuration of the present invention.

FIG. 6 is a view of a release fitting, according to an optional configuration of the present invention.

FIG. 7 is a perspective view of an attachment mounted to a spray gun, according to an optional configuration of the present invention.

FIG. 8 is a perspective view of a cap shown mounted to a spray gun, according to another optional configuration of the present invention.

FIGS. 9A and 9B are perspective views of a base of the cap of FIG. 6, the cap being shown dismounted from the spray gun.

FIGS. 10 and 11 are perspective views of supports mounted to a cap, the supports being provided with conduit housings, according to an optional configuration of the present invention.

FIG. 11A is a perspective view of a needle centered within a conduit housing, according to an optional configuration of the present invention.

FIG. 12 is a perspective view of a removable conduit of the cap shown in FIG. 3.

FIG. 13 is a perspective view of a supply fitting and a release fitting of the removable conduit of FIG. 12.

FIG. 14 is another view of a supply fitting, according to an optional configuration of the present invention.

FIGS. 15 to 17 are different views of a pressure system, according to an optional configuration of the present invention.

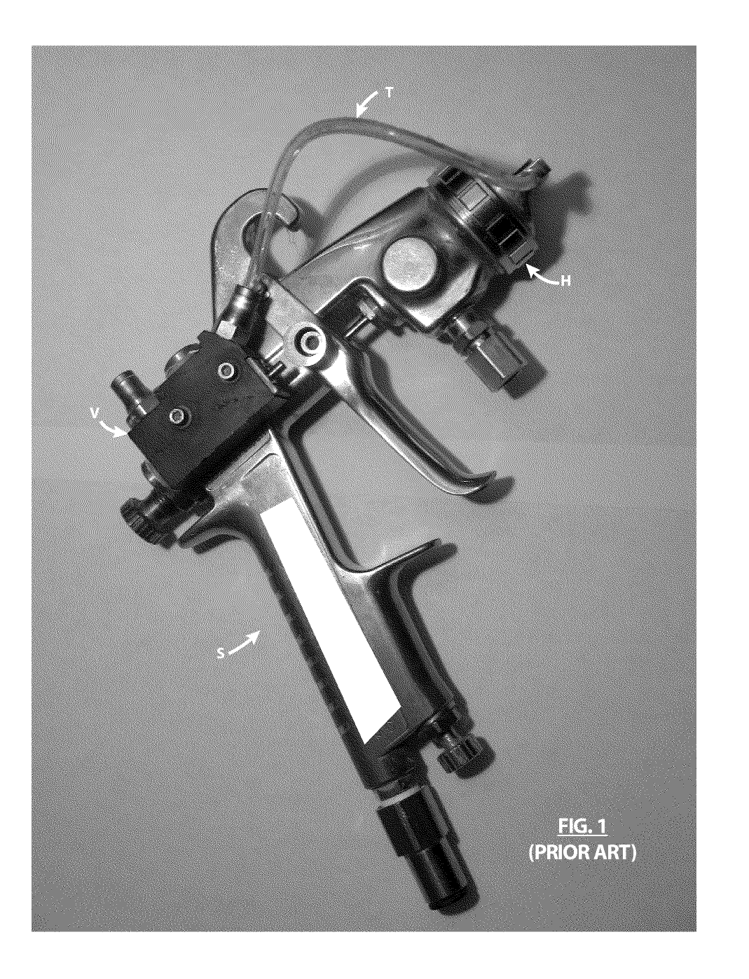

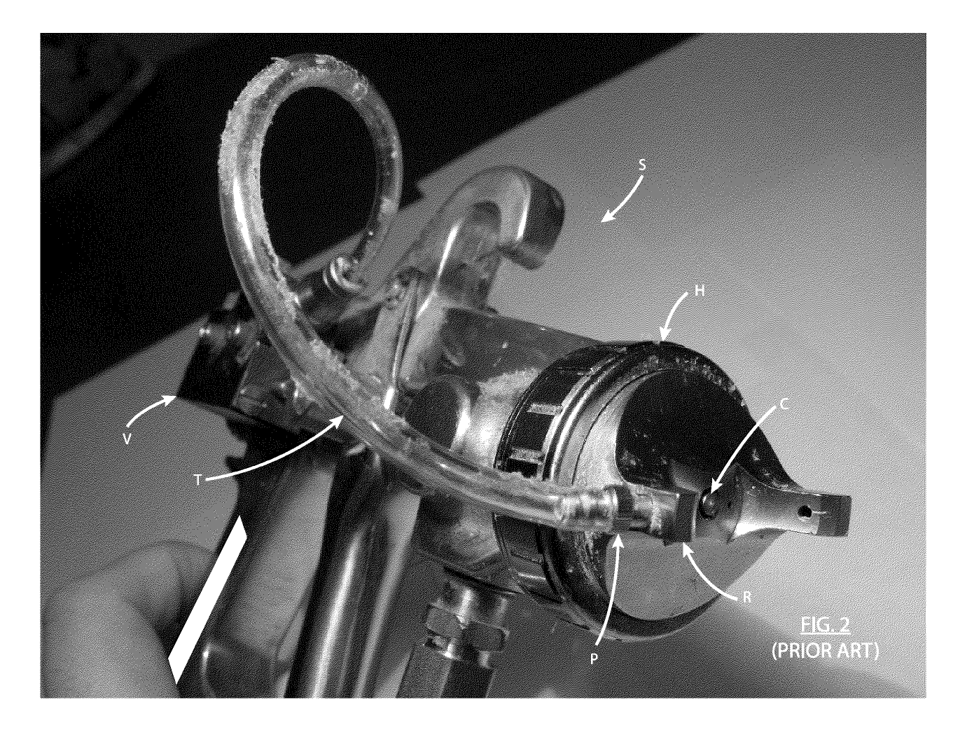

### DETAILED DESCRIPTION OF OPTIONAL EMBODIMENTS

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, although the present invention may be used with a spray gun, for example, it is understood that it may be used with other materials, for other purposes, and with other devices. For this reason, expressions such as “glue”, “paint”, “activator”, “catalyst”, “spray pattern”, “spray gun”, etc. as used herein should not be taken as to limit the scope of the present invention to being used with spray guns in particular. These expressions encompass all other kinds of materials, objects and/or purposes with which the present invention could be used and may be useful.

In addition, although the optional configurations as illustrated in the accompanying drawings comprises various components and although the optional configurations of the cap, gun and system as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the cap, gun and system, and corresponding parts, as briefly explained and as can be easily inferred herefrom, without departing from the scope of the disclosure.

### LIST OF ALPHANUMERICAL REFERENCES FOR SOME OF THE CORRESPONDING OPTIONAL COMPONENTS ILLUSTRATED IN THE ACCOMPANYING DRAWINGS

20. cap
30. base
32. aperture
34. nebulization portal (or simply “portal”)
36. support element
38. conduit housing (or simply “housing”)
38a. receiving element
40. removable conduit (or simply “conduit”)
42. supply fitting
44. release fitting
44a. central axis (or simply “axis”)
44b. centering injector (or simply “injector”)
45. needle
50. pressure system (or simply “system”)
60. fluid receptacle (or simply “receptacle”)
61. inlet
62. hollow body
63. outlet
64. upper surface
66. bottom surface
68. opening
70. receptacle cover (or simply “cover”)
80. regulator for pressurization unit
90. spray gun (or simply “gun”)
92. valve
94. attachment

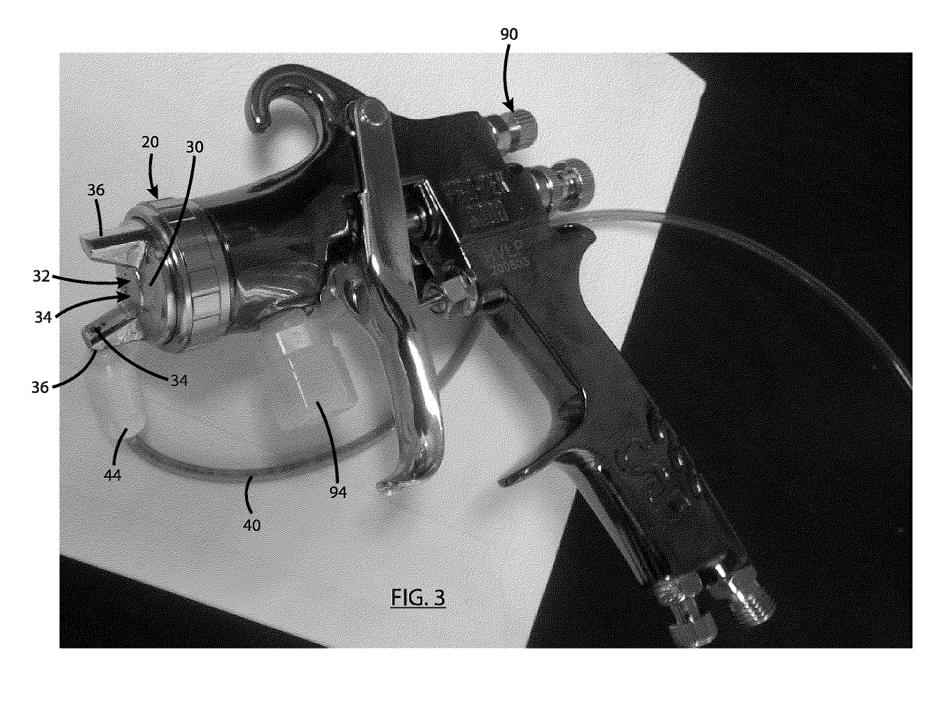

Broadly stated, the present disclosure relates to a cap 20 for a spray gun 90 for spraying a mixture, and an example of such a cap 20 is shown in FIG. 3. The cap 20 can be any head, fixture, top, lid, cover, etc. which can be mounted to the gun 90, or other similar device, so as to contain the pressure of a fluid emanating from the gun 90, and for directing the fluid accordingly. In some optional configurations, the cap 20 is mounted to an end of the gun 90 through which the fluid exits, commonly referred to as the “fluid tip”. Although the cap 20 is described herein as being mounted to a spray gun 90, as previously mentioned, the use of the cap 20 is not limited to this particular configuration, or this particular device. Indeed, the cap 20 can be mounted to any suitable device which outputs one, and/or more fluids, under pressure. For the sole purpose of brevity and concision, the present disclosure will refer to the use of the cap 20 with a spray gun 90, but it will be understood that such use does not limit the cap 20 to being used only with spray guns 90. Similarly, the use of the term “spray” herein does not limit the cap 20 and/or the gun 90 to being used solely for dispersing tiny drops sent through the air. The cap 20 and/or gun 90 can be used to emit more uniform streams of fluid, such as a jet of fluid, for example, and it is understood that other such emissions are also within the scope of the present disclosure.

The gun 90 sprays a mixture of a first fluid and a second fluid. The term “mixture” as used herein refers to any product (vapor, solid, liquid, etc.) obtained by combining the first and second fluids together. The mixture is not limited to having specific values of solubility, completeness, degree of nebulization, etc. The first fluid can be any liquid and/or gas. In some configurations, the first fluid is pressurized. Optionally, the first fluid can be glue or paint in liquid form, which is stored and/or applied under pressure. Similarly, the second fluid can be any liquid and/or gas. Optionally, the second fluid can be an activator or catalyst, which, upon mixing with the first fluid, improves and/or imparts certain properties to the first fluid (i.e. improved bonding, surface adhesion, etc.). The first and second fluids can be combined such that the mixture achieves the desired ratio for a given application. Such a ratio can vary depending on numerous factors, including some of the following non-limitative examples: cost, the nature of the fluids, the surface being sprayed, regulatory requirements, etc.

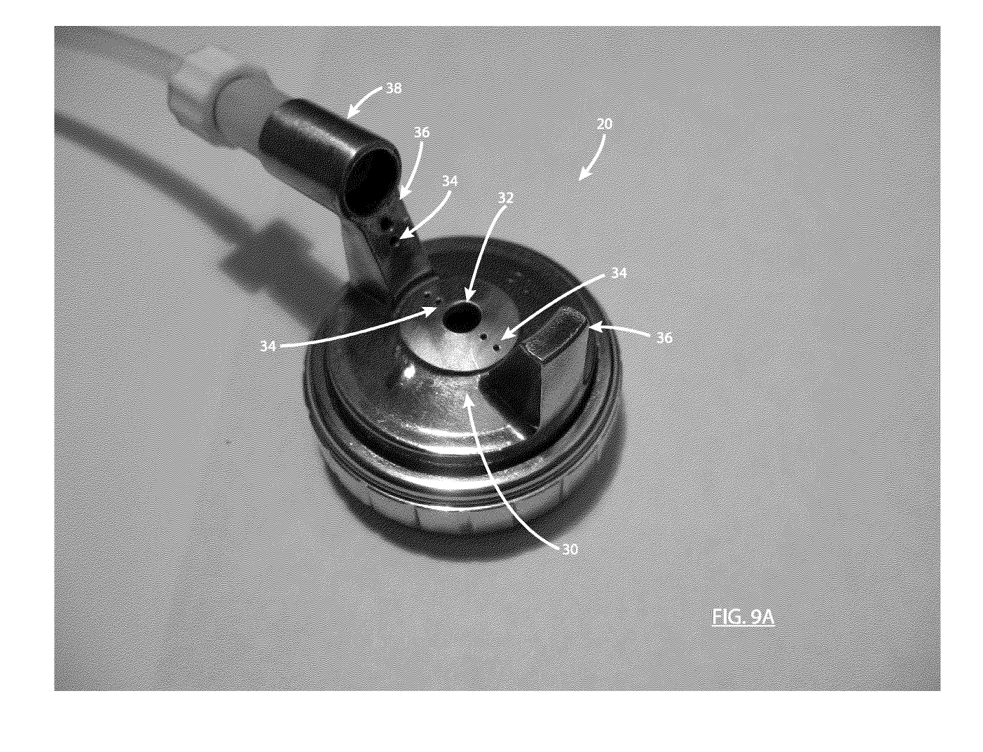

Referring to FIG. 3, the cap 20 includes a base 30. FIGS. 8 to 14 show a cap according to another optional embodiment. The base 30 is the portion of the cap 20 intended to be mounted to the gun 90 so as to form a seal therewith. The base 30 can be mounted to the fluid tip of the gun 90, and removed therefrom as required (i.e. for maintenance, replacement, inspection, etc.). In most configurations, the first and second fluids are supplied to the base 30 under pressure. In such configurations, it is desirable that the base 30 be sealed so as to prevent pressure from escaping the cap 20 and/or to prevent the fluids from leaking. As such, the base 30 can be provided, or be integrated with, any suitable fitting which can be mounted to the gun 90 so as to achieve such functionality. Optionally, the base 30 can be provided with suitable seals, gaskets, stoppers, etc. to further enhance its liquid and/or pressure retention. In some optional configurations, the base 30 is circular, although other shapes and/or forms are possible. Further optionally, the base 30 can comprise a retaining ring which secures an air cap to the gun 90.

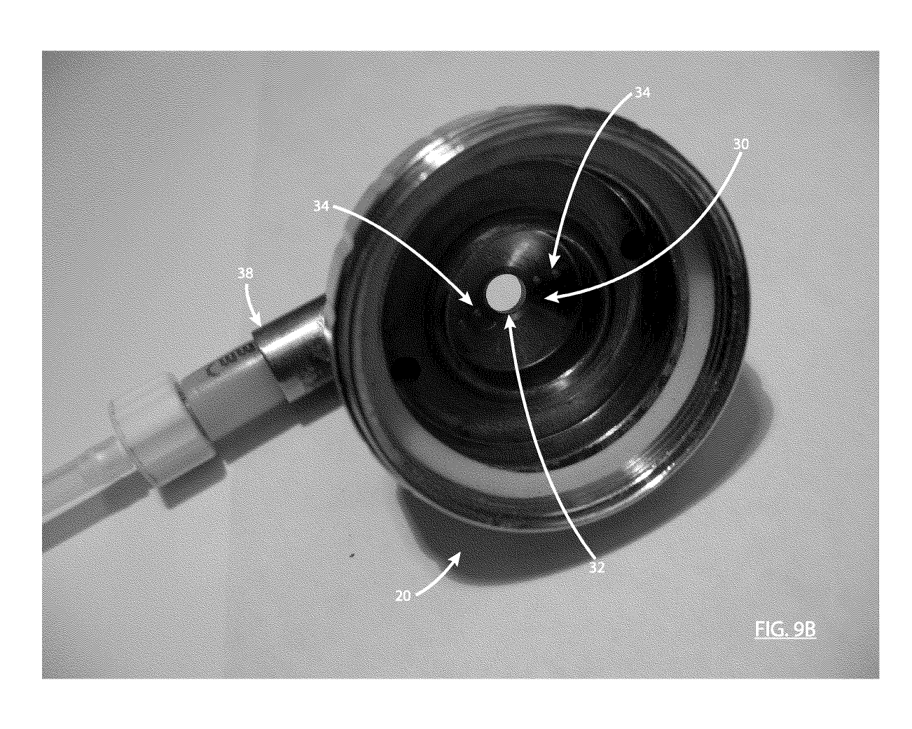

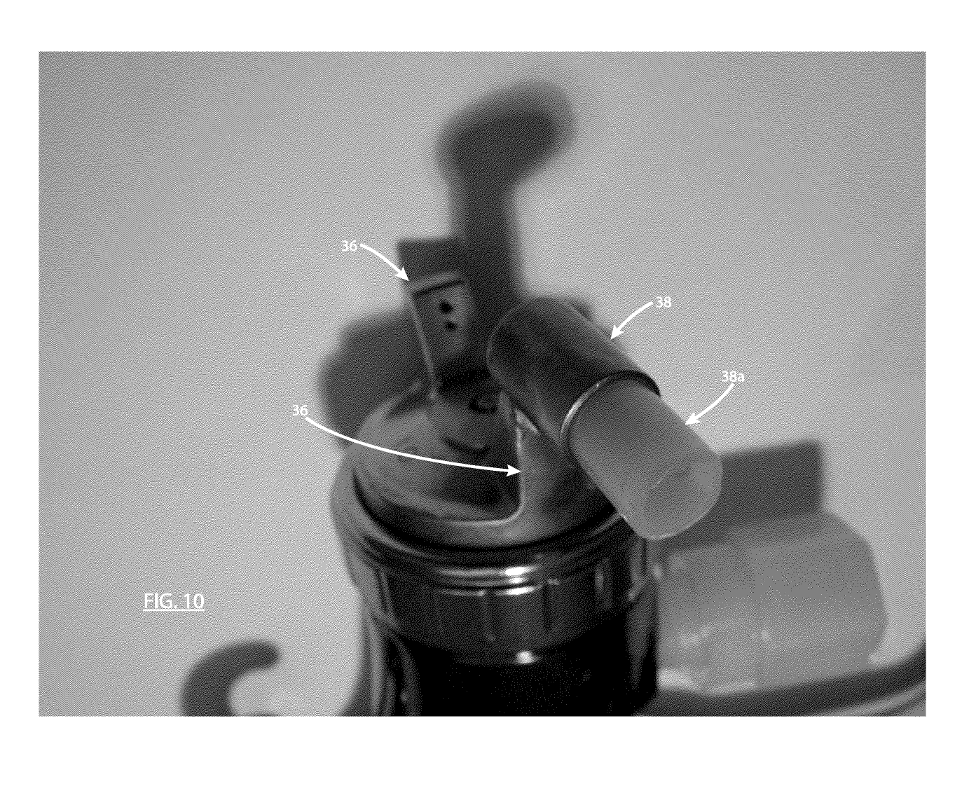

The base 30 includes an aperture 32. The aperture 32 can be any hole, opening, passage, etc. through which the first fluid passes. In the optional configuration shown in FIG. 3 or 9A-9B, the aperture 32 is circular, but it is understood that the aperture 32 can be any shape, and/or take on any form, which allows the above-mentioned passage of the first fluid. In some optional configurations, the base 30 can include nebulization portals 34, which can be located near the aperture 32. The portals 34 allow for the injection of any pressurized gas, often air, into the first and/or second fluid streams, thereby aiding in the nebulization of the fluids, if desired.

The aperture 32 is in fluid communication with a supply of the first fluid when it is mounted to the gun 90. The expression “fluid communication” refers to the exchange of fluid (i.e. the receipt of the first fluid) from the supply. Such communication can be accomplished by any suitable mechanism, such as tubing, ducts, channels, pipes, etc. The “supply” can be any source exterior of the gun 90 from which the first fluid originates. As such, the supply can be any tank, system, reservoir, source, etc. which can store and deliver, under pressure or not, the first fluid to the aperture 32. The aperture 32 is configured for spraying the first fluid. By “configured” it is understood that the shape, configuration, form, etc. of the aperture 32 itself, and/or the passage of the first fluid through the aperture 32, can disperse the first fluid into a spray, the width of which can be adjusted, as desired.

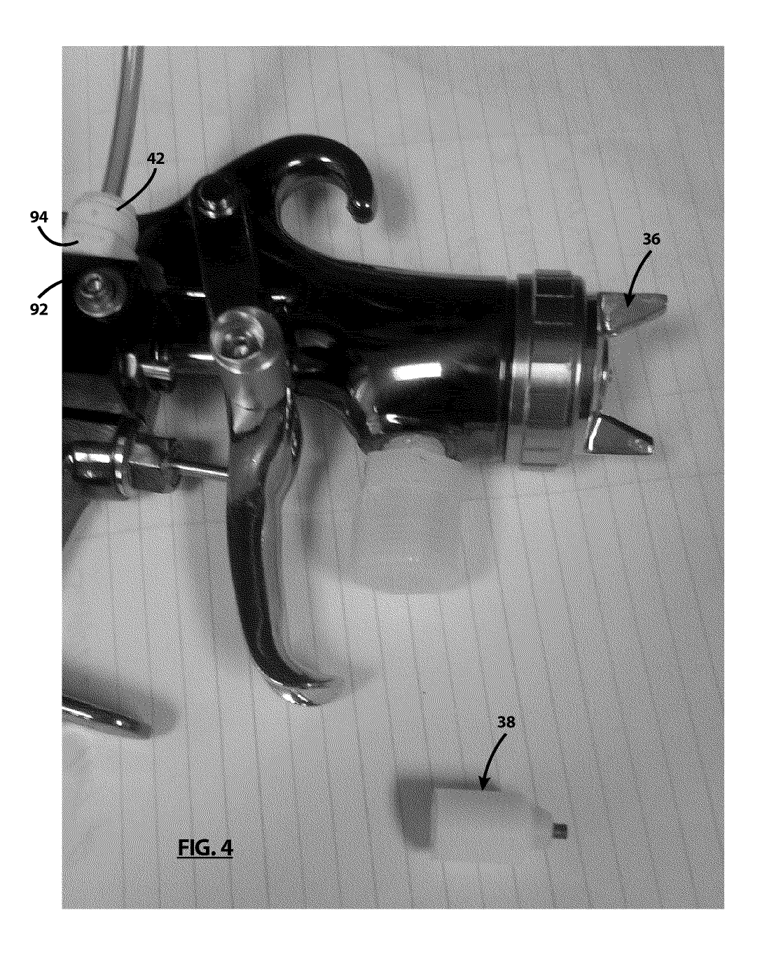

In some optional configurations, the base 30 includes at least one support element 36. The support element 36 can be any prong, projection, spur, horn, etc. which projects from the base 30 substantially in the direction of the spray. Optionally, two such support elements 36 are provided on the base 30, and the support elements 36 are positioned on the base 30 in opposed relation, an example of which is shown in FIG. 4A. The support elements 36 can also be inclined relative to the base 30, and may be inclined toward the rim of the base 30. In such a configuration, the support elements 36 may delimit the maximum width the spray may achieve, advantageously preventing the spray width from exceeding a desired maximum width. The support elements 36 may include nebulization portals 34 therein.

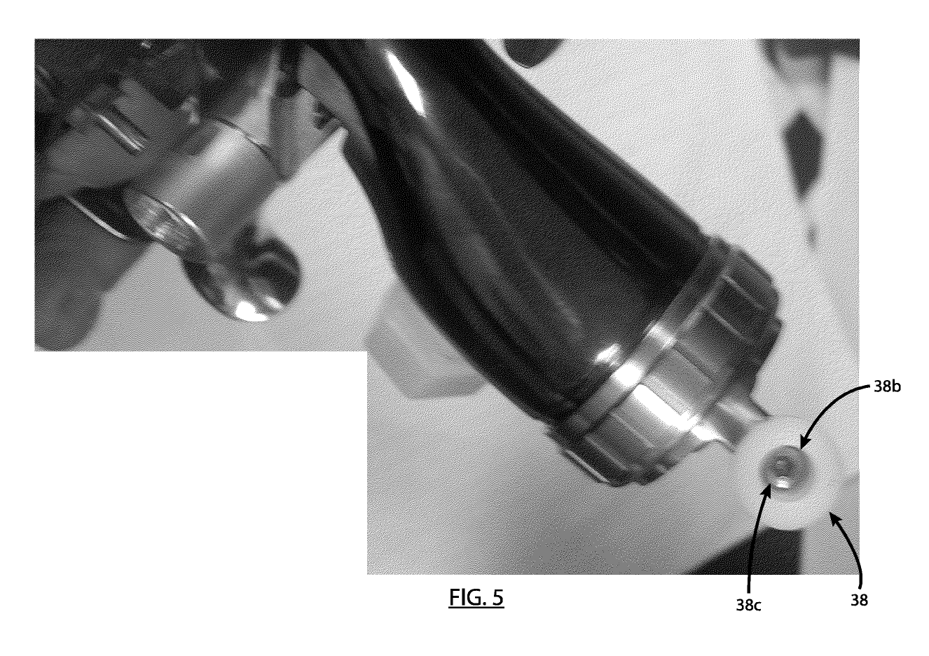

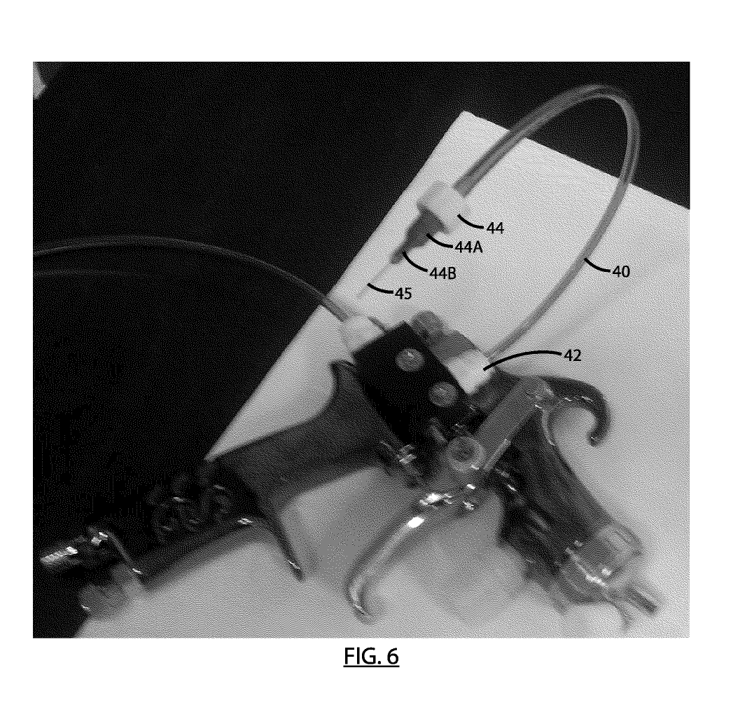

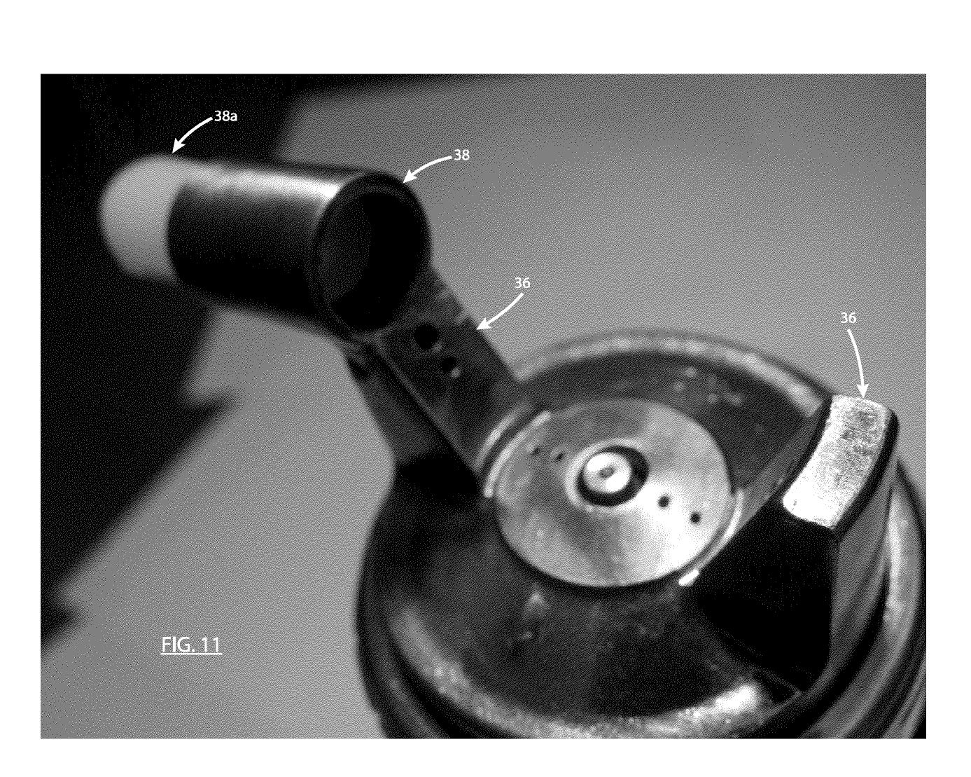

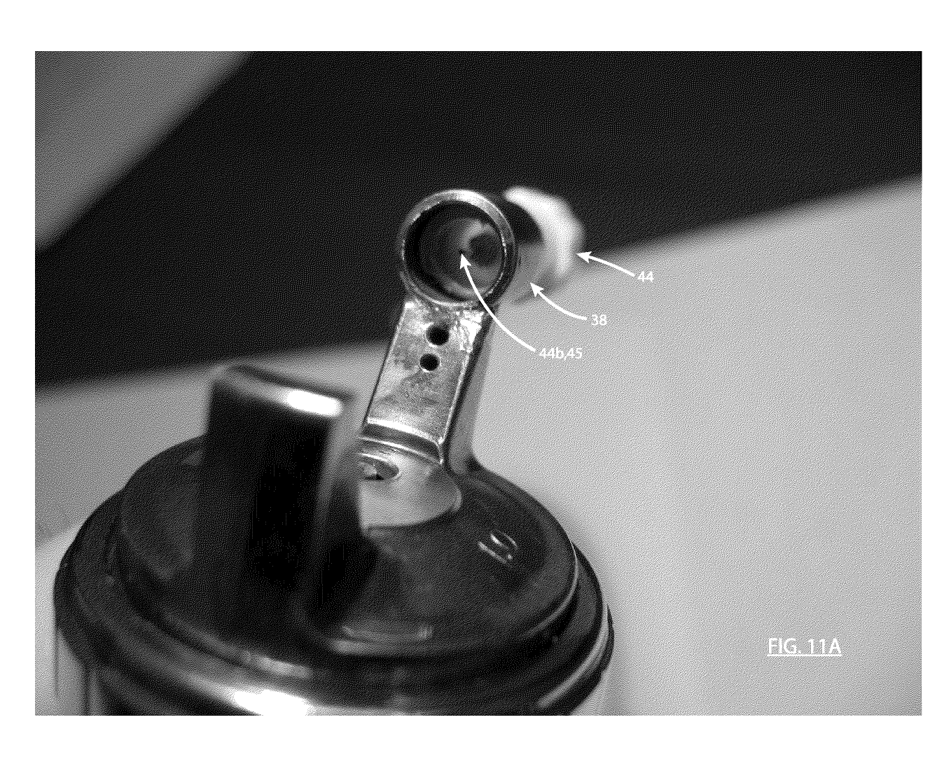

In some optional configurations, examples of which are provided in Figures FIGS. 4-5 or FIGS. 10-11, at least one support element 36 can include a conduit housing 38 which is mounted thereto. The housing 38 can be mounted to the support element 36, or multiple support elements 36, using various techniques. One example of such a technique is to weld the housing 38, which in this example is made of a weldable metal, to a top end of the support element 36. Alternatively, the support element 36 and housing 38 can securely mate through a groove/flange configuration, which can alert the operator of a secure connection when a “clicking” noise is heard. The conduit housing 38 is intended to house, shelter, encase, and center etc. the conduit discussed below. As such, and although shown as cylindrical in FIGS. 5 and 6, the housing 38 can take any shape and/or form which is hollow, which can be mounted to the support element 36 and/or which can securely receive the conduit. The housing 38 can be made from any suitable material (i.e. metals, polymers, etc.). The choice of which material to use can vary based on numerous factors such as cost, how the housing 38 is mounted to the support element 36, the fluids being used, etc. In some optional configurations as shown in FIGS. 10-11, the housing 38 can include a receiving element 38a. The receiving element 38a can be securely fitted to the housing 38 using any suitable technique (i.e. press-fitted, welded, snapped, etc.). The receiving element 38a can act as an intermediary between the housing 38 and the conduit. Advantageously, the receiving element 38a can allow the housing 38 to receive and support a release fitting of any size, thereby increasing the scope of conduits that can be used with the cap. Referring to the embodiment shown in FIGS. 4 and 5, the conduit housing 38 can include a threaded-passage 38b and a centering element 38c which centers the conduit and protects it so that it can inject the fluid in a predetermined direction.

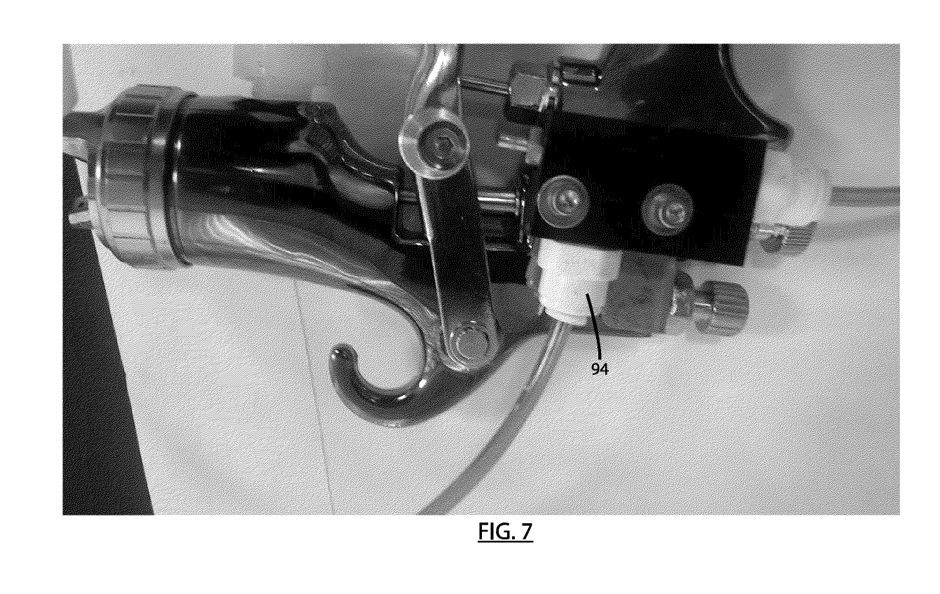

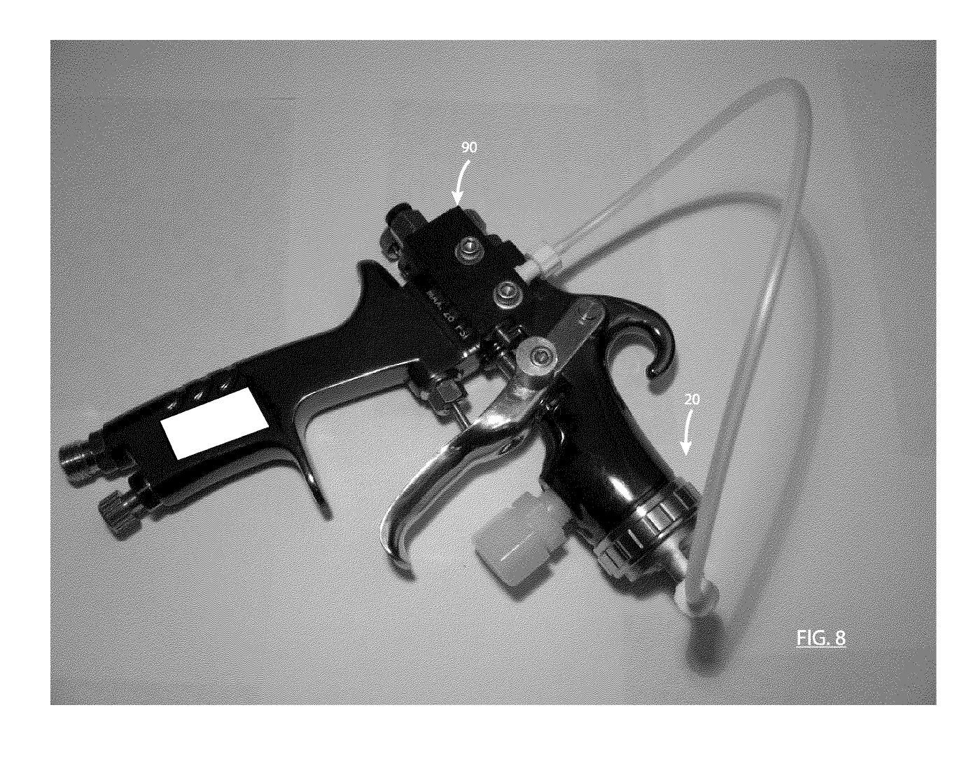

Referring to FIG. 3 or FIGS. 7 and 8 for another optional embodiment, the cap 20 includes a removable conduit 40 as well. The conduit 40 conveys under pressure the second fluid to the base 30, where it can ultimately be combined with the first fluid so as to form the mixture. As such, the conduit 40 can be any tubing, channel, tunnel, passage, etc. of any shape and/or form, that can be easily removed and attached to the base 30, and which can transmit the second fluid under pressure to the base 30. As with the supply of the first fluid discussed above, the supply of the second fluid can come from any pressurized source. The conduit 40 herein described can be a component of the cap 20 or integrated therewith, or can be stand-alone component, which can be purchased so as to adapt an existing gun 90, and which can be disposed of and replaced when no longer useful while still preserving the use of the cap 20 and/or its other components.

The conduit 40 extends between two opposed fittings, the supply fitting 42 and the release fitting 44. The fittings 42,44 are removably mountable to different parts of the gun 90. The expression “removably mountable” as used herein refers to the functionality of the fittings 42,44 which can be easily removed from the gun 90, and which can be easily mounted thereto.

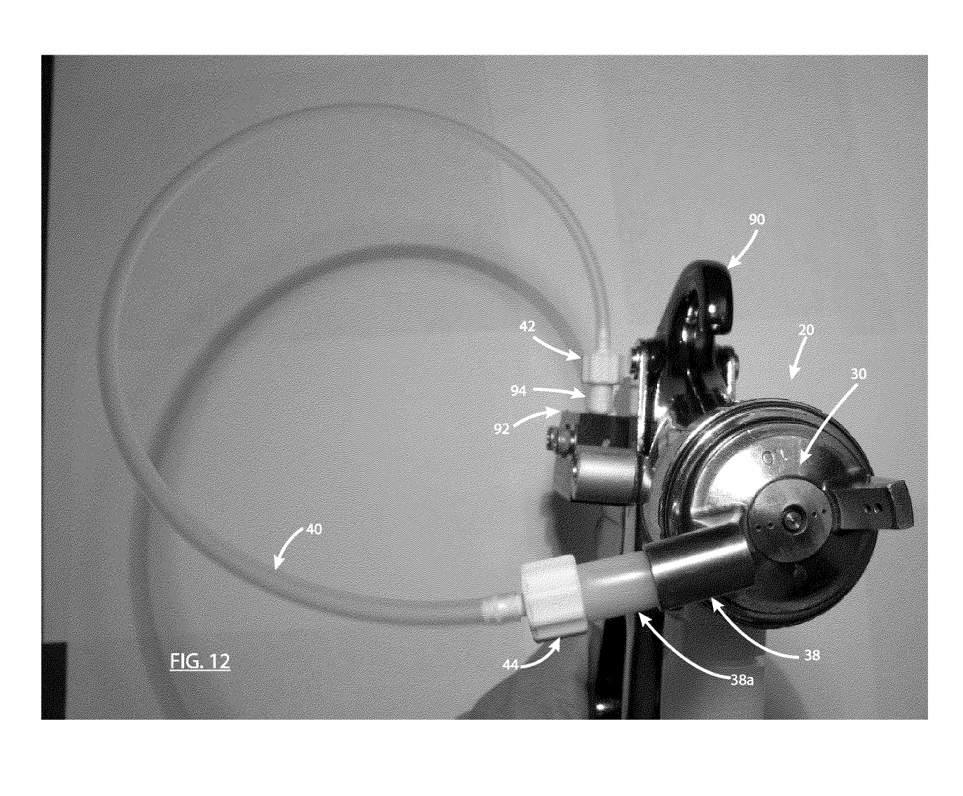

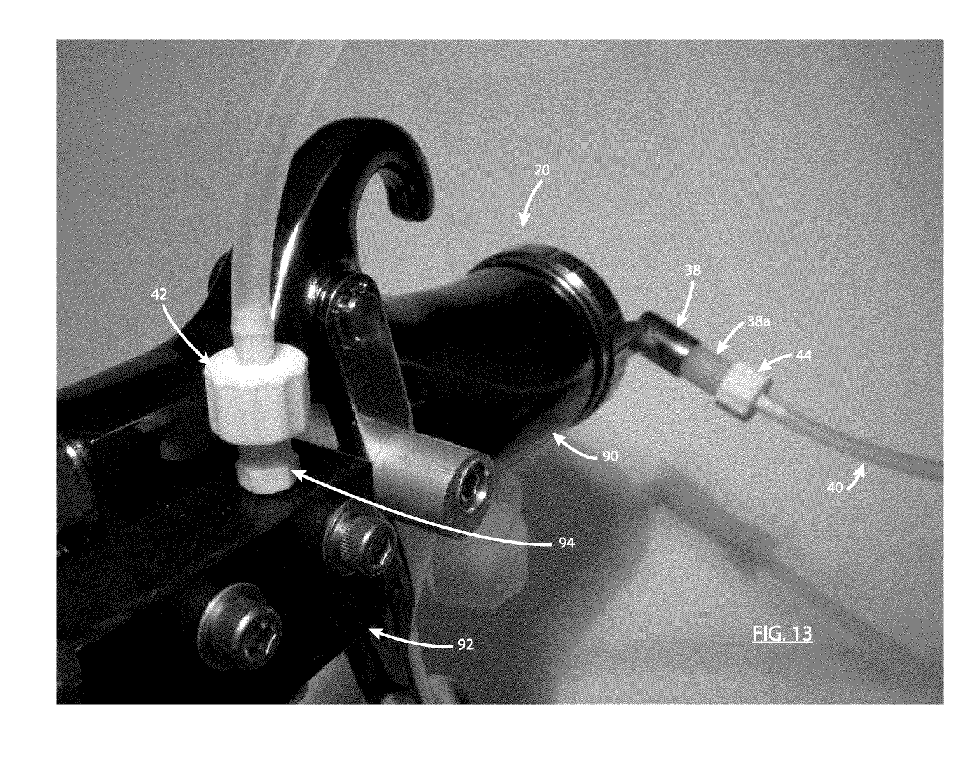

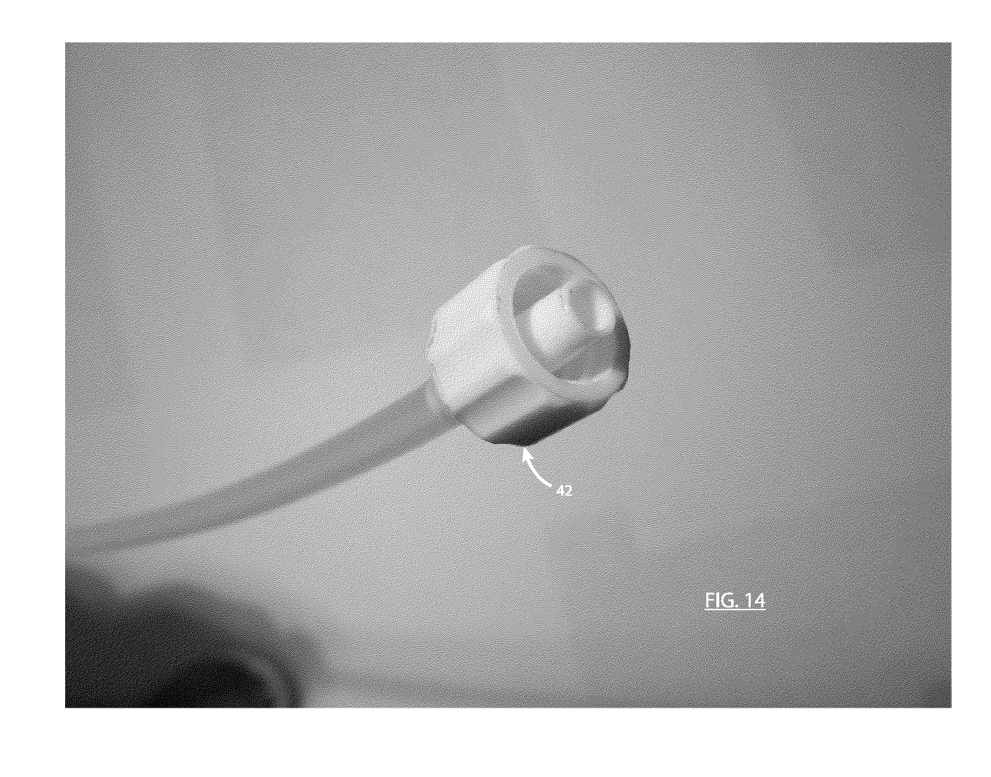

The supply fitting 42 is in fluid communication with a supply of the second fluid. As previously explained, the supply of the second fluid can be any tank and/or system which stores and delivers the second fluid under pressure. Alternatively, the supply can be a device between the source of the second fluid and the base 30. Indeed, in one example of the supply fitting 42 shown in FIGS. 12 and 13, the supply fitting 42 is mounted to a valve 92 of the gun 90 which receives the second fluid directly from the source. The supply fitting 42 can be mounted to a corresponding attachment 94 fitted to the gun. Such a mounting can occur through techniques such as press fitting, click-attachment, threaded fitting, etc. The attachment 94 can be made from any suitable material, such as plastics, polymers, composites, etc., for example, and can be mounted to one of the ports of the gun 90, as shown in FIGS. 11 and 12. In some optional configurations, an example of which is provided by FIG. 14, the supply fitting 42 can be a male fitting, such as those commercialized under the name LUER-LOK™, for example. This type of supply fitting 42 can then mate with a female LUER-LOK™, for example, which can be the attachment 94.

Referring to FIG. 6, the release fitting 44 is on an opposite end of the conduit 40 as the supply fitting 42. The release fitting 44 is also removably mountable to the base 30, such that it can easily be affixed to the base 30, and removed therefrom. The release fitting 44 can be removably mounted to the base 30 such that the second fluid is injected into the first fluid at any angle thereto (i.e. co-directionally with the first fluid, perpendicularly or obliquely intersecting it, etc.). The release fitting 44 mounts to the base 30 such that it can direct the second fluid at a fixed orientation. In some optional configurations, the second fluid is released from the release fitting 44 as a stream of liquid into the first fluid, thereby mixing with the first fluid. It can thus be desirable to ensure that this stream of liquid is constantly released at the same orientation so as to produce the desired mixture having the desired ratios, even after repeated uses of the release fitting 44, and even when the release fitting 44 and/or needle 45 is clogged and needs to be replaced.

One optional technique to regulate the orientation of the released second fluid is to provide the release fitting 44 with a central axis 44a. The central axis 44a can be any centrality, direction, focus, etc. that is centrally located within the release fitting 44. The central axis 44a can be a physical feature, or it can merely characterize a middle of the release fitting 44. The central axis 44a does not limit the shape of the release fitting 44 to being tubular, although such a shape can be used. The release fitting 44 can be any suitable shape, which is provided with a substantially-hollow and centrally-located passage. The second fluid can thus be directed along the central axis 44a, advantageously allowing for the second fluid to be directed into the first fluid along a fixed orientation, thereby forming the mixture.

Another optional technique for regulating the orientation of the released second fluid is to fixedly mount the release fitting 44 to the housing 38, as shown in FIGS. 4 and 5. Optionally, the release fitting 44 can be mounted to one of, or both, support elements 36. Such a secure mounting can be achieved with many techniques such as press fitting, click-attachment, threaded fitting, etc. When the release fitting 44 is thus securely mounted to the housing 38, the second fluid may be advantageously directed along a fixed orientation, and this, through many uses of the gun 90. Optionally in another optional embodiment shown in FIG. 12-13, the release fitting 44 may be fixedly mounted to the receiving element 38a, thus advantageously allowing release fittings 44 of various sizes to be used.

Yet another optional technique for regulating the orientation of the released second fluid is to provide the release fitting 44 with a centering injector 44b, an example of which is shown in FIG. 6. The centering injector 44b can be any narrow, centrally-located device which conveys the second fluid into the first fluid along a central direction. In some optional configurations, the centering injector 44b can have a narrowing taper, where it narrows along its length from where the second fluid enters the centering injector 44b, to where the second fluid exits. The centering injector 44b could thus be a cone, for example.

Optionally, the centering injector 44b can be a needle 45. In such a configuration, the needle 45 can be integrated into a female LUER-LOK™, for example, which can be mounted to a male LUER-LOK™ of the release fitting 44. In the embodiments shown in FIGS. 4 and 5, the needle 45 can also mate with the centering piece 38c by being screwed through the threaded-passage 38b. This configuration advantageously allows only the needle 45 to quickly and rapidly be disposed of when it is damaged or clogged, while still preserving the other components of the cap 20. The needle 45 can be press-fitted, or otherwise securely mounted, to the housing 38 and/or to the receiving element 38a for the optional embodiment shown in FIGS. 12-13. Such a secure mounting ensures that the needle 45 is continuously fixed in its orientation, thereby advantageously helping to maintain the orientation of the second fluid constant, such as along the central axis 44a, as shown in FIG. 6. Further advantageously, such a secure mounting may allow the needle 45 to be more resistant if dropped to the floor or impacted while being used. In yet another advantage, the mounting of the needle 45 to the housing 38 can protect the operator form accidentally being pricked by the needle 45.

Further advantageously, the gage of the needle 45 can vary depending on the desired ratio of the mixture, among other factors. In the example where the needle 45 is used to inject an activator, when a higher gage needle 45 is used, less activator is used but the probability of the needle 45 becoming clogged increases. It can thus be appreciated that the selection of the needle's 45 gage can allow for the easy determination of an operator of the ratios of first/second fluids, such as by using a chart, for example.

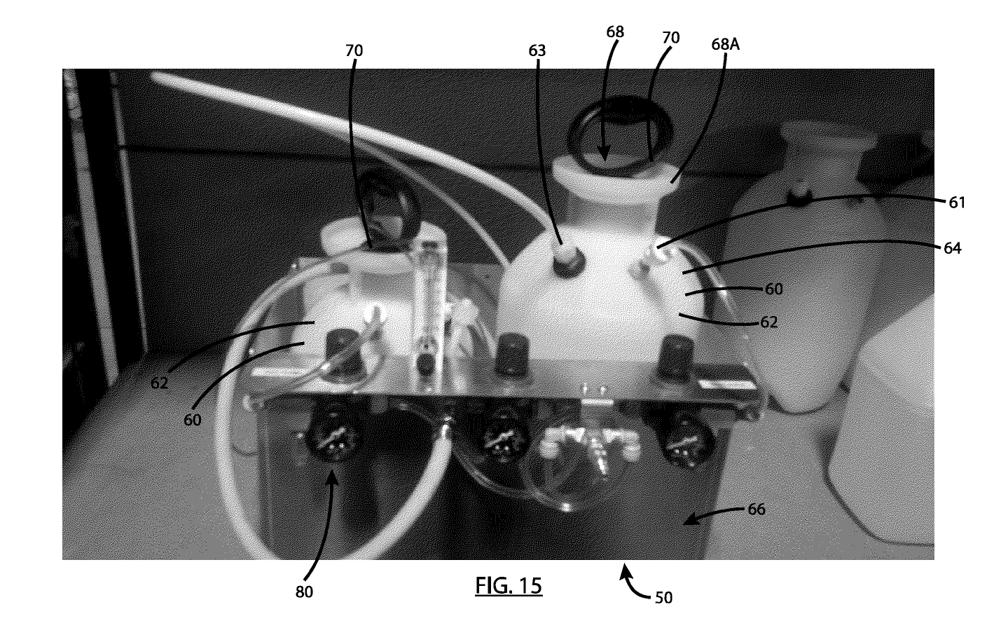

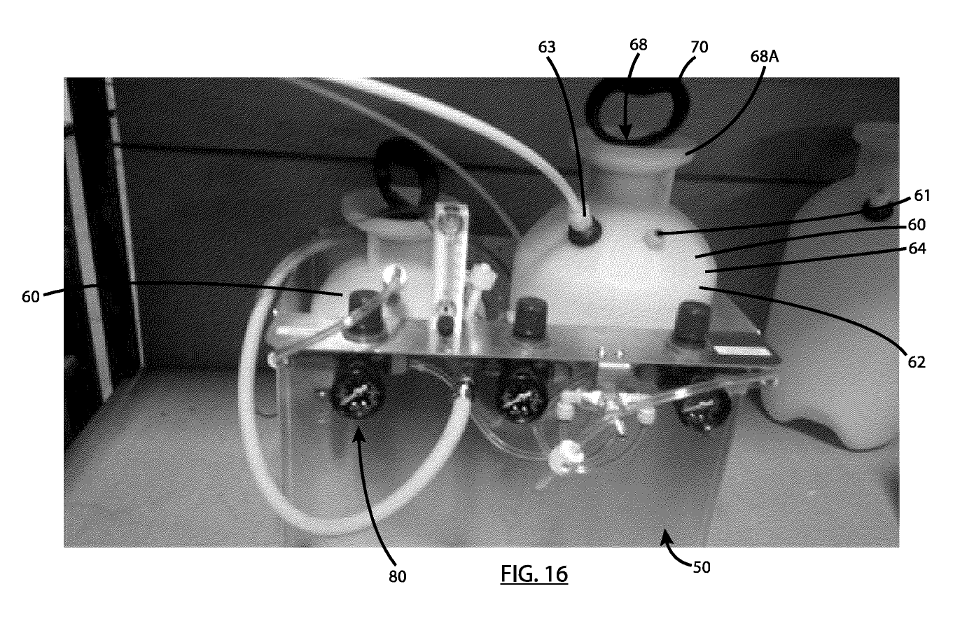

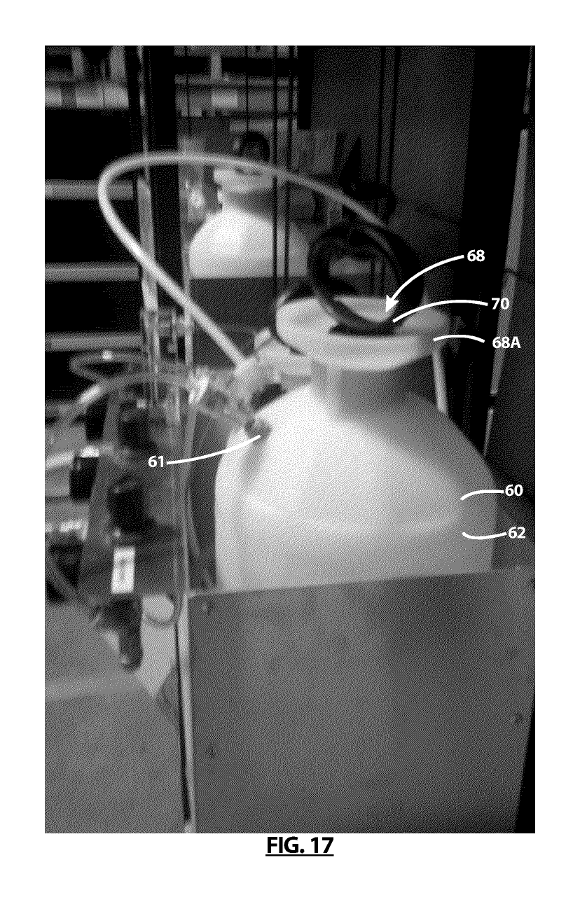

Broadly stated, and as shown in FIGS. 15 to 17, the present disclosure also relates to a pressure system 50 for pressurizing the first and second fluids, so as to be used with the gun 90 described above, for example. The system 50 can be used so as to pressurize a glue and an activator, for example, so that such fluids can be sprayed under pressure via the spray gun 90 against a surface. In some optional configurations, the system 50 is provided with a mobile unit, such as a trolley, for example, so as to advantageously allow the operator to displace the system 50 as required.

The system 50 includes two fluid receptacles 60. Although two receptacles 60 are herein described and shown in FIGS. 15 to 17, it is understood that more or fewer receptacles 60 can be used without departing from the scope of the present disclosure. Each receptacle 60 stores a separate fluid, often under pressure. Each receptacle 60 can therefore be any tank, container, canister, vessel, etc. which can store the fluids under pressure. The pressure within each receptacle 60 can vary depending on numerous factors, some of which include the nature of the fluids being pressurized, the application for which they will be used, the material of the receptacle 60, etc. Optionally, the receptacles 60 can be made of a relatively light material, such as polymers, hard or soft plastics or composite materials (or similarly characterized materials). Each fluid receptacle 60 can take any shape or form, or be permanent or disposable, such that it is capable of receiving a fluid and conveying the fluid under pressure.

In the embodiments shown in FIGS. 15 to 17, each receptacle 60 consists of a hollow body 62, which extends between an upper surface 64 and a bottom surface 66. The shape and/or form of the upper surface 64 can vary. Indeed, in one possible such variant, the upper surface 64 is a substantially planar, horizontal surface. In another possible variant, an example of which is shown in FIG. 15, the upper surface 64 is a cylindrically-tapering hollow extension, which extends upward from the hollow body 62. In some optional embodiments, the upper surface 64 can define an opening 68 within itself. In one possible example of such a configuration, the opening 68 is a hole located within the middle of upper surface 64. The opening 68 can take any shape or form which is conducive to facilitating the receiving of fluids within the receptacle 60. In an optional configuration, the opening 68 comprises a funnel 68a, which can channel the fluids directly into the opening 68, thereby facilitating the storage of fluids in the receptacles 60. Each receptacle 60 can also be provided with an inlet 61 through which the pressurize gas is received, and an outlet 63 from which the pressurised fluids are conveyed. The inlet 61 and outlet 63 can be located on an easily-accessible portion of the receptacle 60, such as the hollow body 62 and/or the upper surface 64. The inlet 61 and the outlet 63 can be provided with appropriate seals, gaskets, valves, etc. so as to maintain a consistent level of pressure within each receptacle 60.

The system 50 also includes two fluid couplers for coupling the receptacles to feed lines of the spray gun system. In the embodiments shown in FIGS. 15 to 17, the fluid couplers are plastic fittings positioned at the outlet 63. In alternate embodiments, the fluid couplers can be tap or valve systems that are quickly and/or removably connectable to the receptacles to allow an easy connection between the receptacle and the feed lines for the spray gun system. Examples of tap systems include tap systems including keg valves or the like. Examples of valve systems include container valve systems that are removably or permanently connectable (for a single use) to the receptacles for dispensing fluids therefrom. In other examples, the fluid coupler may be, but is not limited to, Micromatic™ valves that are used in closed chemical systems in agricultural or any other specialized chemical or fluid applications. However, any type of fluid coupler that can be connected to the receptacle for extracting fluid and transmitting the fluid to the spray gun system feed lines may be considered.

In some optional configurations, the system may also include screwable receptacle covers 70, each cover 70 being removably mountable to a corresponding receptacle 60. More or fewer covers 70 can also be provided, if necessary. The term “screwable” or “mountable” used herein can refer to the nature of the removable mounting between the cover 70 and the receptacle 60. In some optional configurations, the cover 70 has a threaded portion which can mate with a corresponding threaded portion of the receptacle 60, thereby forming a seal which can resist the pressures within the receptacle 60. The operator may use a handle attached to the cover 70 so as to screw the cover 70 into the receptacle 60. Optionally, the cover 70 is removably screwed onto the opening 68. The cover 70 is not limited to a screwable mounting, and can also be mounted using other techniques such as snap-fitting, press-fitting, click-attachment, etc. This can advantageously allow for the refilling of the receptacle 60 by simply removing the cover 70, and thus there is no need to shut down the entire system 50 or remove the entire upper surface 64 of the receptacle 60.

The system 50 also includes a pressurization unit. The pressurization unit supplies a pressurized fluid, typically air but not limited to this particular fluid, into each receptacle 60, preferably through a regulator 80. The addition of this pressurized fluid increases the pressure within each receptacle 60 until it reaches the desired level. The unit can be any pump, motor, system, etc. which can supply a relatively constant pressurized fluid to each receptacle 60. The unit can be provided with appropriate valves, gauges, tubing, regulators, etc. and other such devices so as to enable the operator to monitor the pressure in each receptacle 60, among other things.

In an example of a typical operation of the system 50, the covers 70 are first unscrewed so as to add the first and second fluids to the receptacles 60. Once the desired volume of fluids are added, the covers 70 are screwed onto the opening 68 of each receptacle 60 until a sealed-connection is achieved. The system 50 can then be pressurized using the pressurization unit through the regulator 80 until the desired pressure is achieved in each receptacle, and the fluids can then be sprayed, applied, etc. using an appropriate device (i.e. a spray gun). This can advantageously allow for the refilling of the receptacle 60 by simply removing the cover 70, The system 50 also can also have a flow meter to meter the catalyst or second fluid in the correct quantity, as well as check valves to stop fluid backflowing to an air regulator. The system 50 can also have pressure safety valves to limit pressure to about 40 psi.

The present invention offers advantages over the prior art in that, by virtue of its design and components, the cap 20 may adapt and/or retrofit a conventional spray gun 90 so that a second fluid can be injected into the center of a first fluid so as to ensure a thorough mixing of the first and second fluids.

In contrast to some other devices in the field of spray guns used to apply glue, the clogging of components of the cap 20 and/or gun 90 causes very little trouble to the operator. Indeed, should any component of the cap 20 clog, these components can be easily removed and replaced with affordable parts, which reduces the time required by the operator to unclog the component, and lowers his costs.

Furthermore, the housing 38 and/or receiving element 38a are shaped, positioned, and sized such that the needle 45 does not project past the housing 38, thus preventing it from contacting the operator, and further protecting the needle from being fouled by material. Moreover, the configuration of the receiving element 38a advantageously can allow for the mere insertion of the needle 45 therein to result in automatic centering, without further adjustment being required. The availability of the needle 45 in many different gage sizes can allow for the amount of the second fluid to be adjusted by simply changing gage size. In addition, only the needle 45 need be removed from the receiving element 38a and/or housing 38 whenever the needle clogs, thereby saving the operator time and resources. The needle 45 can also be easily removed as desired to verify the ratio of first to second fluids where such ratios require continuous monitoring. Furthermore, the needle 45 advantageously can reduce the possibility of the second fluid being atomized when being mixed with the first fluid, and such functionality is important where the second fluid can cause irritation to the operator.

In addition, the receptacles 60 of the system 50 can be made from plastic, as but on example, which renders them lighter and thus easier to manipulate by the operator, and also cheaper to manufacturer, lowering the operator's costs. The use of the mobile unit also improves the manipulability of the system 50 by the operator. Furthermore, the covers 70 can offer a quick, secure technique for filling the receptacles 60.

Of course, numerous modifications could be made to the above-described configurations without departing from the scope of the disclosure.

1. A cap for a spray gun for spraying a mixture of a first fluid and a second fluid, the cap comprising:
a base removably mountable to the spray gun, the base comprising:
an aperture in fluid communication with a supply of the first fluid upon being mounted to the spray gun, the aperture configured for spraying the first fluid; and
a secondary port for receiving the second fluid to be mixed with the first fluid; and
a removable conduit for conveying under pressure the second fluid to the secondary port, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid, thereby forming the mixture.

2. The cap according to claim 1, wherein the base further comprises at least one support element projecting from the base in a direction away from the gun, the support element comprising a conduit housing for housing the conduit.

3. The cap according to claim 2, wherein the base comprises two support elements delimiting a width of a spray pattern from the gun.

4. The cap according to claim 2, further comprising a receiving element positioned within the housing, the receiving element being connectable to the release fitting.

5. The cap according to claim 1, wherein the release fitting comprises a centering injector for conveying the second fluid into the first fluid along a central direction.

6. The cap according to claim 1, further comprising nebulization ports positioned proximate the aperture and the secondary port for nebulizing the first and second fluids.

7. A removable fluid injector for a fluid-delivery device for delivering a mixture of a first fluid and a second fluid, the fluid injector comprising:
a removable conduit for conveying under pressure the second fluid to a secondary port of the device, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid emitted by the device, thereby forming the mixture.

8. The fluid injector according to claim 1, wherein the release fitting comprises a centering injector for conveying the second fluid into the first fluid along a central direction.

9. A spray gun system for spraying a mixture of a first fluid and a second fluid, the spray gun comprising a cap, the cap comprising:
a base removably mountable to the spray gun, the base comprising:
an aperture in fluid communication with a supply of the first fluid upon being mounted to the spray gun, the aperture configured for spraying the first fluid; and
a secondary port for receiving the second fluid to be mixed with the first fluid; and
a removable conduit for conveying under pressure the second fluid to the secondary port, the conduit extending between a supply fitting in fluid communication with a supply of the second fluid and removably mountable thereto, and an opposed release fitting removably mountable to the secondary port, the release fitting being positioned, shaped and sized for directing the second fluid into the first fluid, thereby forming the mixture.

10. The spray gun system according to claim 9, further comprising a pressure system for pressurizing the supplies of the first fluid and the second fluid, the pressure system comprising:
two fluid receptacles, each fluid receptacle comprising a hollow body, each fluid receptacle configured for storing one of the first and second fluids within the hollow body;
two fluid couplers for coupling the receptacles to feed lines of the spray gun system, each coupler mountable to a corresponding receptacle so as to form a pressurized seal with said receptacle; and
a pressurization unit configured for supplying a pressurized fluid to each fluid receptacle, thereby pressurizing the first and second fluids in their corresponding receptacles.

11. The spray gun system according to claim 10, wherein the hollow body is made of a material selected from the group comprising hard plastic, soft plastic and composite materials.

12. The spray gun system according to claim 10, further comprising a displacement system for facilitating displacement of the pressure system.

13. The spray gun system according to claim 10, wherein the fluid couplers are selected from the group comprising tap systems and valve systems.

14. The pressure system according to claim 13, wherein each fluid receptacle comprises an opening, and the pressure system further comprises screwable covers insertable into corresponding openings of the fluid receptacles.

15. The pressure system according to claim 14, further comprising a funneling structure formed in each opening for channeling fluids therethrough.

16. A pressure system for pressurizing supplies of a first fluid and a second fluid fed into a spray gun system, the pressure system comprising:
two fluid receptacles, each fluid receptacle comprising a hollow body, each fluid receptacle configured for storing one of the first and second fluids within the hollow body;
two fluid couplers for coupling the receptacles to feed lines of the spray gun system, each coupler mountable to a corresponding receptacle so as to form a pressurized seal with said receptacle; and
a pressurization unit configured for supplying a pressurized fluid to each fluid receptacle, thereby pressurizing the first and second fluids in their corresponding receptacles.

17. The pressure system according to claim 16, wherein the hollow body is made of a material selected from the group comprising hard plastic, soft plastic and composite materials.

18. The pressure system according to claim 16, further comprising a displacement system for facilitating displacement of the pressure system.

19. The pressure system according to claim 16, wherein the fluid couplers are selected from the group comprising tap systems and valve systems.

20. The pressure system according to claim 19, wherein each fluid receptacle comprises an opening, and the pressure system further comprises screwable covers insertable into corresponding openings of the fluid receptacles.

21. The pressure system according to claim 20, further comprising a funneling structure formed in each opening for channeling fluids therethrough.
